(19) United States
(12) Patent Application Publication
(10) Pub. No.: US 2011/0204043 A1
(43) Pub. Date: Aug. 25, 2011

(54) RADIO-FREQUENCY HEATING APPARATUS

(76) Inventor: Toshio Ishizaki, Hyogo (JP)

(21) Appl. No.: 13/124,720

(22) PCT Filed: Jul. 12, 2010
(86) PCT No.: PCT/JP2010/004508

§ 371 Date: Apr. 18, 2011

(30) Foreign Application Priority Data
Jul. 13, 2009 (JP) 2009164746

(51) Int. Cl. H05B 6/10

(52) U.S. Cl. 219/647

(57) ABSTRACT

A radio-frequency heating apparatus includes a heating chamber, first and second radio-frequency wave generation devices from which radio-frequency waves are radiated, and a control unit that controls the first and second radio-frequency wave generation devices. Each of the first and second radio-frequency wave generation devices includes: a radiation unit that radiates radio-frequency waves into the heating chamber; and a backward wave demodulation unit that demodulates backward waves entering from the heating chamber. The backward wave demodulation unit of the first radio-frequency wave generation device detects reflected waves that are radio-frequency waves radiated from the radiation unit and reflected back into the radiation unit, and through waves that are radio-frequency waves radiated from another radiation unit and enter the radiation unit. The control unit controls the first and second radio-frequency wave generation devices based on the detected reflected waves and through waves.

### TECHNICAL FIELD

The present invention relates to radio-frequency heating apparatuses, and in particular to a radio-frequency heating apparatus including a plurality of radio-frequency wave generation devices, each of which has an amplifier using a semiconductor device.

### BACKGROUND ART

Conventional radio-frequency heating apparatuses typically include oscillator devices using vacuum tubes called magnetrons.

In recent years, radio-frequency heating apparatuses including, instead of the magnetron, an oscillator and an amplifier which uses a semiconductor device have been considered. Such radio-frequency heating apparatuses can be small in size and low in cost and are capable of controlling frequencies with ease. PTL 1 discloses a technique of heating an object in a preferred state by detecting backward waves under various conditions that are set by changing a phase difference and frequencies of radio-frequency waves radiated from radiation units in a plurality of radio-frequency wave generation units, and performing a control to set such a condition that the backward waves are smallest.

### [Citation List]

### [Patent Literature]

[Patent Literature 1]

Japanese Unexamined Patent Application Publication No. 2008-269793 (Refer to FIG. 1)

### SUMMARY OF INVENTION

### Technical Problem

However, with the structure of the conventional radio-frequency heating apparatus disclosed by PTL 1, among what are called backward waves that enter the radiation units from a heating chamber, reflected waves that are radiated from the radiation unit of one of the radio-frequency wave generation devices and are reflected back to the radiation unit, and through waves that are radiated from the radiation unit of another one of the radio-frequency wave generation devices and enter the radiation unit of the one of the radio-frequency wave generation devices, cannot be separately detected. This imposes a problem of inability to measure a radiation loss of the radio-frequency waves for each of the radio-frequency wave generation devices, which radiation loss is calculated by adding up, among the radio-frequency waves radiated from one of radiation units, the reflected waves that return to the radiation unit by reflection and the through waves that enter another radiation unit. Specifically, since it is unknown which one of the radio-frequency wave generation devices has a high radiation loss in the whole radio-frequency heating apparatus, there is no clue as to which one of the radio-frequency wave generation devices is to be controlled for reducing the radiation loss, causing a problem of an enormous length of time required for optimization processing of radio-frequency heating.

The present invention has been conceived in order to solve the above problems, and an object of the present invention is to provide a radio-frequency heating apparatus which is capable of separately detecting, in one of radiation units, reflected waves that are radiated from the one of the radiation units and return to the one of the radiation units by reflection and through waves that are radiated from another one of the radiation units and enter the one of the radiation units.

### Solution to Problem

In order to solve the above problems, a radio-frequency heating apparatus according to an aspect of the present invention includes: a heating chamber in which an object to be heated is placed; a plurality of radio-frequency wave generation devices from which radio-frequency waves are radiated into the heating chamber; and a control unit configured to control the radio-frequency wave generation devices, wherein each of the radio-frequency wave generation devices includes: a radio-frequency wave generation unit configured to generate the radio-frequency waves; a signal wave generation unit configured to generate signal waves for modulating the radio-frequency waves generated by the radio-frequency wave generation unit; a radiation unit configured to radiate modulated waves into the heating chamber, the modulated waves being obtained by modulating, using the signal waves, the radio-frequency waves generated by the radio-frequency wave generation unit; and a backward wave demodulation unit configured to detect backward waves which are part of the modulated waves and enter the radiation unit from the heating chamber, the backward wave demodulation unit is configured to demodulate the backward waves based on the modulated waves to detect reflected backward waves and pass-through backward waves, the reflected backward waves (i) being part of the radio-frequency waves radiated from the radiation unit of one of the radio-frequency wave generation devices and (ii) being reflected back into the radiation unit of the one of the radio-frequency wave generation devices, and the pass-through backward waves (i) being part of the radio-frequency waves radiated from the radiation unit of another one of the radio-frequency wave generation devices and (ii) entering the radiation unit of the one of the radio-frequency wave generation devices, and the control unit is configured to control at least one of the radio-frequency wave generation devices based on signals of the reflected backward waves detected by the backward wave demodulation unit and signals of the pass-through backward waves detected by the backward wave demodulation unit.

Furthermore, in the radio-frequency heating apparatus according to an aspect of the present invention, the control unit is preferably configured to determine a frequency of the radio-frequency waves which are to be generated by the radio-frequency wave generation unit, based on the signals of the reflected backward waves detected by the backward wave demodulation unit and the signals of the pass-through backward waves detected by the backward wave demodulation unit.

Furthermore, in the radio-frequency heating apparatus according to an aspect of the present invention, the control unit is preferably configured (i) to determine one of the radio-frequency wave generation devices in which the frequency of the radio-frequency wave generation unit is to be changed, based on the signals of the reflected backward waves detected by the backward wave demodulation units and the signals of the pass-through backward waves detected by the backward wave demodulation units, and (ii) to determine the frequency of the radio-frequency waves which are to be generated by the radio-frequency wave generation unit, based on the signals of the reflected backward waves and the signals of the pass-through backward waves obtained when the frequency of the radio-frequency wave generation unit in the determined one of the radio-frequency wave generation devices is changed.

Furthermore, in the radio-frequency heating apparatus according to an aspect of the present invention, the control unit is preferably configured to determine an amplification gain of an amplifier, based on the signals of the reflected backward waves detected by the backward wave demodulation unit and the signals of the pass-through backward waves detected by the backward wave demodulation unit.

Furthermore, in the radio-frequency heating apparatus according to an aspect of the present invention, the control unit is preferably configured (i) to determine one of the radio-frequency wave generation devices in which the amplification gain of the amplifier is to be changed, based on the signals of the reflected backward waves detected by the backward wave demodulation units and the signals of the pass-through backward waves detected by the backward wave demodulation units, and (ii) to determine the amplification gain of the amplifier, based on the signals of the reflected backward waves and the signals of the pass-through backward waves obtained when the amplification gain of the amplifier in the determined one of the radio-frequency wave generation devices is changed.

Furthermore, in the radio-frequency heating apparatus according to an aspect of the present invention, preferably, the backward wave demodulation unit includes a first demodulator and a second demodulator, the first demodulator demodulates, using signals of the modulated waves received from the one of the radio-frequency wave generation devices, signals of the backward waves received from the radiation unit, the second demodulator demodulates, using signals of the modulated waves received from the other one of the radio-frequency wave generation devices, the signals of the backward waves received from the radiation unit, and the signals of the backward waves demodulated by the first demodulator and the second demodulator are provided to the control unit.

### Advantageous Effects of Invention

According to the present invention, in one of the radiation units, the reflected waves that are radiated from the one of the radiation units and return to the one of the radiation units by reflection, and the through waves that are radio-frequency waves radiated from another one of the radiation units and entering the one of the radiation units can be separately detected. This enables specifying and controlling the radio-frequency wave generation device which has a high radiation loss when reducing a radiation loss, so that the optimization of a heating condition can be performed efficiently.

### BRIEF DESCRIPTION OF DRAWINGS

[FIG. 1]

FIG. 1 is a block diagram showing a structure of a radio-frequency heating apparatus according to an embodiment of the present invention.

[FIG. 2]

FIG. 2 is a block diagram showing a structure of a backward wave demodulation unit of a radio-frequency heating apparatus according to the embodiment of the present invention.

[FIG. 3]

FIG. 3 is a flowchart showing a control procedure for a radio-frequency heating apparatus according to the embodiment of the present invention.

[FIG. 4]

FIG. 4 shows reflected waves and through waves in a plurality of radio-frequency wave generation devices of a radio-frequency heating apparatus according to the embodiment of the present invention.

[FIG. 5]

FIG. 5 shows appearance of a microwave oven that is an example of a radio-frequency heating apparatus according to the embodiment of the present invention.

### DESCRIPTION OF EMBODIMENTS

The following describes a radio-frequency heating apparatus 100 according to an embodiment of the present invention with reference to the drawings.

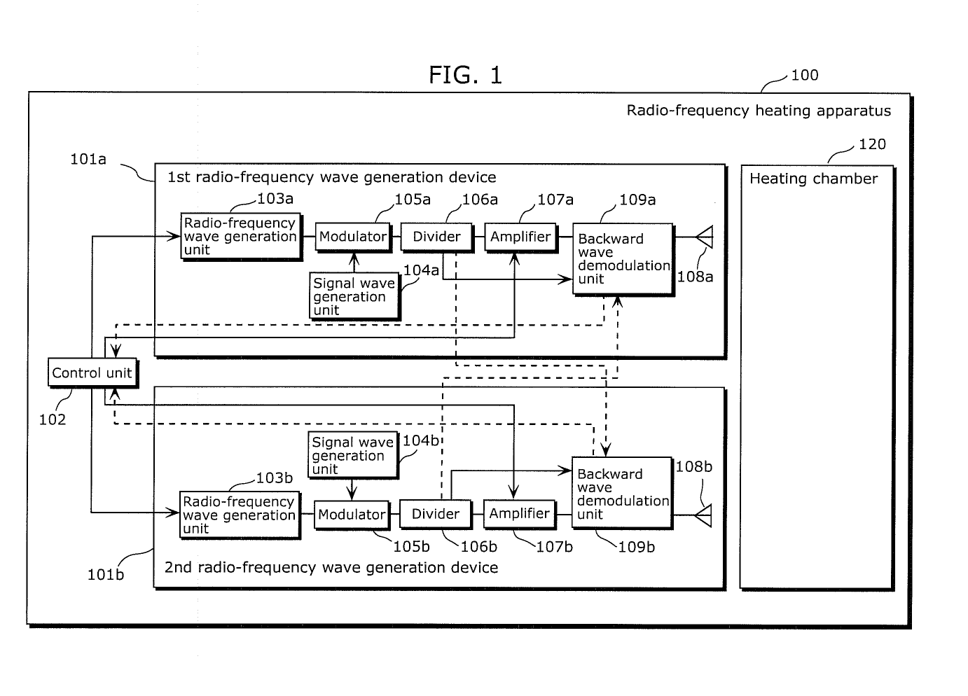

FIG. 1 is a block diagram showing a structure of the radio-frequency heating apparatus 100 according to the embodiment of the present invention.

As shown in FIG. 1, the radio-frequency heating apparatus 100 according to the embodiment of the present invention includes a first radio-frequency wave generation device 101a, a second radio-frequency wave generation device 101b, a control unit 102, and a heating chamber 120 in which an object to be heated is placed.

First, the first radio-frequency wave generation device 101a and the second radio-frequency wave generation device 101b are described.

The first radio-frequency wave generation device 101a is a radio-frequency wave generation device from which predetermined radio-frequency waves are radiated into the heating chamber 120, and includes a radio-frequency wave generation unit 103a, a signal wave generation unit 104a, a modulator 105a, an amplifier 107a, a radiation unit 108a, and a backward wave demodulation unit 109a.

Likewise, the second radio-frequency wave generation device 101b is also a radio-frequency wave generation device from which predetermined radio-frequency waves are radiated into the heating chamber 120, and includes a radio-frequency wave generation unit 103b, a signal wave generation unit 104b, a modulator 105b, an amplifier 107b, a radiation unit 108b, and a backward wave demodulation unit 109b.

In the first radio-frequency wave generation device 101a and the second radio-frequency wave generation unit 101b, the radio-frequency wave generation units 103a and 103b generate radio-frequency waves and output the radio-frequency waves to the respective modulators 105a and 105b.

Each of the signal wave generation units 104a and 104b generates signal waves and outputs the signal waves to a corresponding one of the modulators 105a and 105b.

Each of the modulators 105a and 105b modulates, using the signal waves provided from a corresponding one of the signal wave generation units 104a and 104b, the radio-frequency waves provided from a corresponding one of the radio-frequency wave generation units 103a and 103b, and outputs the modulated radio-frequency waves (modulated waves) to a corresponding one of dividers 106a and 106b.

Each of the dividers 106a and 106b divides, for a corresponding one of the amplifiers 107a and 107b and a corresponding one of the backward wave demodulation units 109a and 109b, the radio-frequency waves which are the modulated waves received from a corresponding one of the modulators 105a and 105b, and outputs a part of the radio-frequency waves to a corresponding one of the amplifiers 107a and 107b and another part of the radio-frequency waves to a corresponding one of the backward wave demodulation units 109a and 109b.

Each of the amplifiers 107a and 107b amplifies the radio-frequency waves (modulated waves) received from a corresponding one of the dividers 106a and 106b, and outputs the amplified radio-frequency waves to a corresponding one of the backward wave demodulation units 109a and 109b. Furthermore, in the present embodiment, each of the amplifiers 107a and 107b is a variable gain amplifier that is capable of changing an amplification gain, and this amplification gain is determined based on an external input control signal indicating an amplification gain. In the present embodiment, the amplification gain is determined based on an amplification gain signal provided from the control unit 102.

Each of the radiation units 108a and 108b radiates, into the heating chamber 120, the radio-frequency waves which are modulated waves received from a corresponding one of the amplifiers 107a and 107b.

The backward wave demodulation unit 109a of the first radio-frequency wave generation device 101a demodulates, using the radio-frequency waves provided from the divider 106a, the backward waves that are part of the radio-frequency waves radiated from the radiation unit 108a or the radiation unit 108b and provided from the heating chamber 120 to the radiation unit 108a, and outputs the obtained demodulated waves to the control unit 102.

The backward wave demodulation unit 109a of the second radio-frequency wave generation device 101b demodulates, using the radio-frequency waves provided from the divider 106b, the backward waves that are part of the radio-frequency waves radiated from the radiation unit 108a or the radiation unit 108b and provided from the heating chamber 120 to the radiation unit 108b, and outputs the obtained demodulated waves to the control unit 102.

Next, structures of the first radio-frequency wave generation device 101a and the second radio-frequency wave generation device 101b are described in more details.

Each of the radio-frequency wave generation units 103a and 103b includes an oscillator. For this oscillator, a frequency synthesizer using a phase locked loop (PPL) can be used, for example. In the case where PPL is used, an oscillation frequency is determined based on digital data at a given frequency.

Each of the signal wave generation units 104a and 104b generates a base band signal for modulating the radio-frequency waves received from a corresponding one of the radio-frequency wave generation units 103a and 103b. Signaling systems to be generated are of various types and preferably orthogonal GOLD codes or orthogonal code systems based on the Walsh function. Herein, orthogonal means that the cross correlation function obtained by multiplying the respective signal waves by each other and time-integrating them can be regarded as substantially zero. Such a code system is a well-known technique in the field of wireless communication. This corresponds to demodulation using pseudo random noise in the code division multiple access (CDMA) scheme, for example. Also in the present invention, it is possible to separately detect the reflected waves and the through waves by adopting the above technique.

For the modulators 105a and 105b, quadrature modulators or the like are used. Each of the modulators 105a and 105b modulates, using the signal waves received from a corresponding one of the signal wave generation units 104a and 104b, amplitude components and phase components of frequency waves generated by a corresponding one of the radiofrequency wave generation units 103a and 103b.

For the dividers 106a and 106b, resistance dividers are used, for example. Other applicable examples of the dividers 106a and 106b are directional couplers or hybrid couplers.

For the semiconductor device of each of the amplifiers 107a and 107b, a multistage amplifier is applicable in which a heterostructure field effect transistor (HFET) made of gallium nitride (GaN) is provided at the final stage, for example. Power amplifiers using semiconductor devices are capable of amplifying even frequencies in the 2.4 GHz band that is used for microwave ovens, to output at such a level as several hundreds of Watts, along with the recent development of the semiconductor device technique.

Each of the radiation units 108a and 108b is an antenna for radiating radio-frequency waves to the heating chamber 120, and requires a structure which can deal with high output.

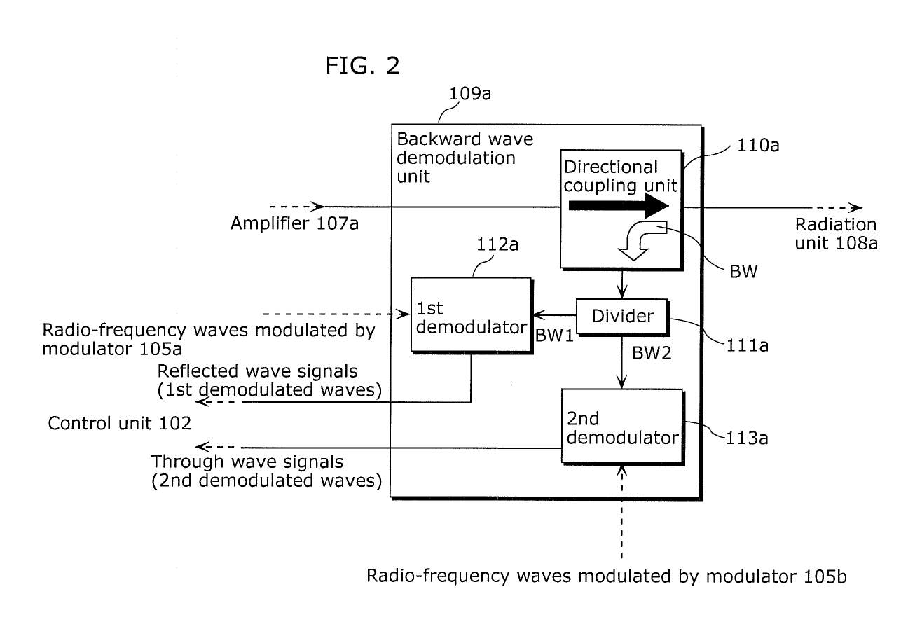

Next, the backward wave demodulation units 109a and 109b of the respective first radio-frequency wave generation device 101a and second radio-frequency wave generation device 101b are described with reference to FIG. 2.

FIG. 2 is a block diagram showing a structure of the backward wave demodulation unit of the radio-frequency heating apparatus according to an embodiment of the present invention. FIG. 2 shows the backward wave demodulation unit 109a of the first radio-frequency wave generation device 101a, of which structure is the same as that of the backward wave demodulation unit 109b of the second radio-frequency wave generation device 101b, a description of which is thus omitted.

In the present embodiment, the backward wave demodulation unit 109a includes a directional coupling unit 110a, a divider 111a, a first demodulator 112a, and a second demodulator 113a.

The directional coupling unit 110a separates backward waves BW that enter the radiation unit 108a from the heating chamber 120 (refer to FIG. 1), and provides the backward waves BW to the divider 111a.

The divider 111a distributes, equally to the first demodulator 112a and the second demodulator 113a, the backward waves BW received from the radiation unit 108a via the directional coupling unit 110a, and provides the distributed backward waves BW to the respective first demodulator 112a and second demodulator 113a as backward waves BW1 and backward waves BW2.

In the meantime, the radio-frequency waves modulated by the modulator 105a (refer to FIG. 1) are divided by the divider 106a (refer to FIG. 1) and then part of the radio-frequency waves is provided to the first demodulator 112a. The first demodulator 112a generates the first demodulated waves by demodulating, using the radio-frequency waves modulated by the modulator 105a, the backward waves BW1 that are one part of the backward waves BW provided from the radiation unit 108a, which one part is obtained through division by the divider 111a, and provides the obtained first demodulated waves to the control unit 102 as reflected wave signals.

Likewise, the radio-frequency waves modulated by the modulator 105b (refer to FIG. 1) are divided by the divider 106b (refer to FIG. 1) and then part of the radio-frequency waves is provided to the second demodulator 113a. The second demodulator 113a generates the second demodulated waves by demodulating, using the radio-frequency waves modulated by the modulator 105b, the backward waves BW2 that are the other part of the backward waves BW provided from the radiation unit 108a, which other part is obtained through division by the divider 111a, and provides the obtained second demodulated waves to the control unit 102 as through wave signals.

The following describes a structure of the backward wave demodulation unit 109a in more detail. This applies also to the backward wave demodulation unit 109b.

The directional coupling unit 110a is well-known, which may use any of a directional coupler, a circulator, and a hybrid coupler.

For the divider 111a, what is applicable to the divider 106a may be used, including a resistance divider, a directional coupler, and a hybrid coupler.

For each of the first demodulator 112a and the second demodulator 113a, an IQ quadrature demodulator may be used, for example.

The first demodulator 112a generates the first demodulated waves by demodulating the above backward waves BW1 using the radio-frequency waves which are generated by the radio-frequency wave generation unit 103a and then modulated by the modulator 105a. This means that, out of the backward waves BW entering the radiation unit 108a, the reflected waves that are part of the radio-frequency waves radiated form the radiation unit 108a and are reflected back to the same radiation unit 108a, can be detected.

The second demodulator 113a generates the second demodulated waves by demodulating the above backward waves BW2 using the radio-frequency waves which are generated by the radio-frequency wave generation unit 103b of the second radio-frequency wave generation device 101b that is another radio-frequency wave generation device, and then modulated by the modulator 105b. This means that, out of the backward waves BW entering the radiation unit 108a, the through waves that are part of the radio-frequency waves radiated form the radiation unit 108b that is different from the radiation unit 108a and enter the radiation unit 108a, can be detected.

It is to be noted that, as mentioned above, the signal waves generated by the signal wave generation unit 104a and the signal waves generated by the signal wave generation unit 104b are orthogonal to each other. That is, the cross correlation function of the signal waves generated by the signal wave generation unit 104a and the signal waves generated by the signal wave generation unit 104b is desirably zero. The cross correlation function is obtained by multiplying the respective signal waves by each other and time-integrating them, and is output from the demodulator as a direct-current voltage. The orthogonal demodulation of orthogonal signal waves thus results in zero output of the demodulator. On the other hand, the orthogonal demodulation of waves modulated using the same signal waves generates an output voltage in the demodulator. This means that, since the signal waves generated by the signal wave generation unit 104a and the signal waves generated by the signal wave generation unit 104b are orthogonal to each other, the demodulation by the first demodulator 112a and the second demodulator 113a enables complete separation of mixed waves of the reflected waves and the through waves which enter the radiation unit, into the reflected wave signals and the through wave signals.

The cross correlation function may be normalized so that the total output voltage in form of the cross correlation function obtained by the first demodulator 112a and the second demodulator 113a becomes 1. The normalization enables the control unit 102 to calculate power of the reflected waves and the through waves by multiplying, by the normalized cross correlation function, a power value of the waves (an added value of the reflected waves and the through waves) which enter the radiation unit 108a.

In the present embodiment, “reflected waves” indicate reflected backward waves that are part of radio-frequency waves radiated from the radiation unit of one of the radio-frequency wave generation devices and are reflected back to the radiation unit of the one (the same radio-frequency wave generation device) of the radio-frequency wave generation devices. “Through waves” indicate pass-through backward waves that are part of radio-frequency waves radiated from the radiation unit of one of the radio-frequency wave generation devices and enter the radiation unit of another one of the radio-frequency wave generation devices which is different from the one of the radio-frequency wave generation devices. In the descriptions, “reflected waves” and “reflected backward waves” indicate the same waves, and “through waves” and “pass-through backward waves” indicate the same waves.

Next, referring back to FIG. 1, the control unit 102 of the radio-frequency heating apparatus 100 according to the present embodiment is described.

The control unit 102 controls the first radio-frequency wave generation device 101a and the second radio-frequency wave generation device 101b and thereby determines frequencies of the radio-frequency waves which are to be generated by the radio-frequency wave generation units 103a and 103b of the respective first radio-frequency wave generation device 101a and second radio-frequency wave generation device 101b.

Specifically, when heating an object in the heating chamber 120, the control unit 102 determines frequencies of the radio-frequency waves which are to be generated by the radio-frequency wave generation units 103a and 103b of the respective first radio-frequency wave generation device 101a and second radio-frequency wave generation device 101b, based on signals (reflected wave signals and through wave signals) which are received from the respective backward wave demodulation units 109a and 109b, and provides, to the radio-frequency wave generation units 103a and 103b, frequency signals corresponding to the determined frequencies. When determining the frequencies, the control unit 102 detects sizes of the reflected waves and the through waves based on the signals (the reflected wave signals and the through wave signals) received from the backward wave demodulation units 109a and 109b, and controls the frequency signals so as to minimize the sizes of the respective reflected waves and through waves.

Furthermore, when heating an object in the heating chamber 120, the control unit 102 determines amplification gains of the amplifiers 107a and 107b of the respective first radio-frequency wave generation device 101a and second radio-frequency wave generation device 101b, based on signals (reflected wave signals and through wave signals) which are received from the respective backward wave demodulation units 109a and 109b, and provides, to the amplifiers 107a and 107b, amplification gain signals corresponding to the determined the amplification gains. When determining the amplification gains, the control unit 102 detects sizes of the reflected waves and the through waves based on the signals (the reflected wave signals and the through wave signals) received from the backward wave demodulation units 109a and 109b, and controls the amplification gain signals so as to minimize the sizes of the respective reflected waves and through waves.

Specifically, the control unit 102 is connected to the radio-frequency wave generation units 103a and 103b and the amplifiers 107a and 107b. The control unit 102 outputs respective frequency control signals to the radio-frequency wave generation units 103a and 103b, and outputs respective amplification gain signals to the amplifiers 107a and 107b. The radio-frequency wave generation units 103a and 103b change frequencies of generated radio-frequency waves according to the respective frequency control signals received from the control unit 102. The amplifiers 107a and 107b change output power according to the amplification gain signals received from the control unit 102.

The control unit 102 is thus capable of performing the optimum radio-frequency heating process by controlling the radio-frequency wave generation units 103a and 103b and the amplifiers 107a and 107b based on the signals (the reflected wave signals and the through wave signals) received from the backward wave demodulation units 109a and 109b.

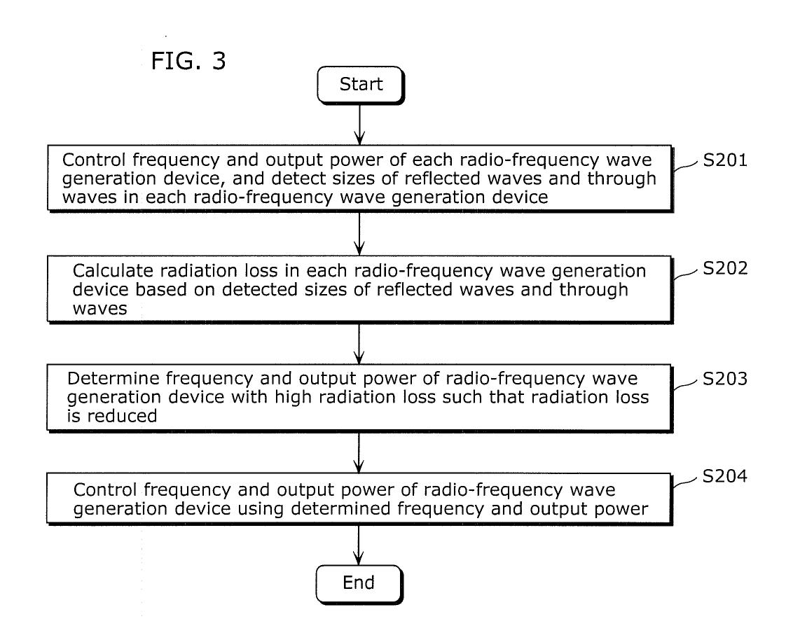

Next, a method of controlling the radio-frequency heating apparatus according to the embodiment of the present invention is described with reference to FIG. 3. FIG. 3 is a flowchart showing a basic control procedure for a radio-frequency heating apparatus according to the embodiment of the present invention. The radio-frequency heating apparatus according to the present embodiment is controlled through processes described below which are performed by the control unit 102 of the radio-frequency heating apparatus 100 shown in FIG. 1.

As shown in FIG. 3, first, the control unit 102 controls frequencies and output power of the respective radio-frequency wave generation devices (the first radio-frequency wave generation device 101a and the second radio-frequency wave generation device 101b), and detects sizes of the reflected waves and the through waves based on the signals of reflected waves and through waves received from the backward wave demodulation units 109a and 109b (S201). At this time, the received signals of reflected waves and through waves may have been normalized using the output power.

Next, on the basis of the detected sizes of the reflected waves and the through waves, radiation losses in the respective radio-frequency wave generation devices (the first radio-frequency wave generation device 101a and the second radio-frequency wave generation device 101b) are calculated (S202). The radiation loss herein indicates power of, among radio-frequency waves radiated from the radiation unit of each of the radio-frequency wave generation devices, the reflected waves that are reflected back to and absorbed by the same radiation unit, and the through waves that enter and are absorbed by another radiation unit. In short, the radiation loss indicates power which is not absorbed by an object to be heated in the heating chamber 120 but is absorbed by any one of the radiation units.

Next, after the radiation losses in the respective radio-frequency wave generation devices (the first radio-frequency wave generation device 101a and the second radio-frequency wave generation device 101b) are calculated, the frequency of the radio-frequency wave generation unit (103a or 103b) and the output power of the amplifier (107a or 107b) in one of the radio-frequency wave generation devices which has a higher radiation loss are determined so that the radiation loss is reduced (S203).

Subsequently, the frequency of the radio-frequency wave generation unit (103a or 103b) and the output power of the amplifier (107a or 107b) are controlled to the determined frequency and output power, respectively (S204). Specifically, as described above, the respective frequency control signals are provided to the radio-frequency wave generation unit (103a or 103b), and the respective amplification gain signals are provided to the amplifier (107a or 107b).

As above, with the structure of the radio-frequency heating apparatus 100 according to the embodiment of the present invention, the reflected waves and the through waves can be separately detected in each of the backward wave demodulation units 109a and 109b, with the result that the radiation loss can be calculated in each of the radio-frequency wave generation devices. With this, one of the radio-frequency wave generation devices which has a higher radiation loss is controlled so that the radiation loss is reduced, which makes it possible to efficiently perform the optimization of radio-frequency heating.

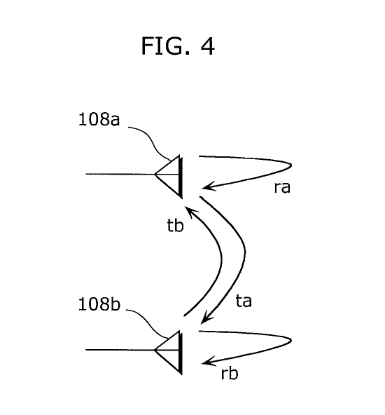

Next, how the reflected waves and the through waves are input to the radiation units of the respective radio-frequency wave generation devices is described with reference to FIG. 4. FIG. 4 shows the reflected waves and the through waves in the plurality of radio-frequency wave generation devices of the radio-frequency heating apparatus according to the embodiment of the present invention.

For example, as shown in FIG. 4, suppose that, for the radiation unit 108a of the first radio-frequency wave generation unit 101a, the reflected waves denoted by ra return to the radiation unit 108a and the through waves denoted by tb are provided from the radiation unit 108b, and for the radiation unit 108b of the second radio-frequency wave generation device 101b, the reflected waves denoted by rb return to the radiation unit 108b and the through waves denoted by to are provided from the radiation unit 108a. Suppose that the output power of the amplifier 107a in the first radio-frequency wave generation device 101a is 200 W and that the output power of the amplifier 107b in the second radio-frequency wave generation device is 150 W. In this case, suppose that the power of the waves which enter the radiation unit 108a of the first radio-frequency wave generation device 101a is 100 W and that the power of the waves which enter the radiation unit 108b of the second radio-frequency wave generation device 101b is 50 W.

Now, suppose the case where the cross correlation function is normalized so that the total output voltage in form of the cross correlation function obtained by the first demodulator 112a and the second demodulator 113a becomes 1. In this case, the reflected wave signals and the through wave signals provided from the backward wave demodulation unit 109a to the control unit 102 have the magnitude of 0.75 and the magnitude of 0.25, respectively, and the reflected wave signals and the through wave signals provided from the backward wave demodulation unit 109b to the control unit 102 have the magnitude of 0.10 and the magnitude of 0.90, respectively.

The control unit 102 detects sizes of the reflected waves and the through waves by multiplying each of these signals by the power of the waves which enter a corresponding one of the radiation units 108a and 108b of the first radio-frequency wave generation unit 101a and the second radio-frequency wave generation unit 101b. In this case, ra is 75 W (=100 W×0.75), tb is 25 W (=100 W×0.25), rb is 5 W (=50 W×0.10), and ta is 45 W (=50 W×0.90). As a result, the control unit 102 finds out that the radiation loss (ra+ta) of the first radio-frequency wave generation device 101a is 120 W and that the radiation loss (rb+tb) of the second radio-frequency wave generation device 101b is 30 W. This shows that the first radio-frequency wave generation device 101a that has a higher radiation loss is to be controlled to reduce the radiation loss. As a specific control method of reducing a radiation loss, the frequency may be determined so that the radiation loss becomes lowest, by, for example, sweeping, within a predetermined range and by predetermined steps, the oscillation frequency of the radio-frequency wave generation unit 103a provided in the first radio-frequency wave generation device 101a.

Furthermore, with the structure according to an implementation of the present invention, there is no need to suspend the heating process in detecting the reflected waves and the through waves separately, which allows for real-time detection of the reflected waves and the through waves in each of the radiation units.

A method of controlling output power is performed by the control unit 102 in a manner described below, for example.

(1) When the frequency is determined in the above-described method, then the withstand voltage of the amplifier at the frequencies is read out from frequency characteristics of the withstand voltage of the amplifier measured and stored in advance. Even in the case where the peak level of a voltage between the source and the drain of the amplifier increases due to backward power, the output power is controlled and determined so as not to exceed the read-out withstand voltage.
(2) A threshold of the backward wave power is determined, for each of the radio-frequency wave generation devices, based on the withstand voltage of the amplifier stored in advance. When the backward wave power exceeds this threshold in each of the radio-frequency wave generation devices, the output power of the radio-frequency wave generation device which is a source of waves with high contribution among these backward waves is controlled so that the backward power becomes equal to or less than the threshold. This means that which radio-frequency wave generation device is to be controlled can be specified, which makes it possible to efficiently perform the optimization.

While the radio-frequency heating apparatus according to an implementation of the present invention has been described above based on the embodiment, the present invention is not limited to the embodiment.

For example, while the radio-frequency wave generation devices include the respective amplifiers 107a and 107b in the present embodiment, the radio-frequency wave generation devices may be configured without the amplifiers 107a and 107b. Even with the configuration without the amplifiers 107a and 107b, the backward wave demodulation units 109a and 109b are capable of separately detecting the reflected waves and the through waves, and using the detected reflected waves and through waves, it is possible to control the radio-frequency wave generation devices.

Furthermore, while the number of radio-frequency wave generation devices according to the present embodiment is two in the above description, the number of radio-frequency wave generation devices according to an implementation of the present invention is not limited. For example, the radio-frequency heating apparatus may be provided with three or more radio-frequency wave generation devices. In this case, with a configuration in which signals which are provided to the demodulators are switched when the backward wave demodulation units detect the through waves, it is possible to detect the backward waves provided from all the radiation units. Alternatively, in this case, a backward wave demodulation unit including the same number of demodulators as the radio-frequency wave generation devices may be provided to detect the backward waves provided from all the radiation units.

Furthermore, while the number of demodulators included in the backward wave demodulation unit according to the present embodiment is two in the above description, the number of demodulators included in the backward wave demodulation unit according to an implementation of the present invention is not limited. For example, the backward wave demodulation unit may be provided with only one demodulator. In this case, with a configuration in which signals which are provided to the demodulators are switched, it is possible to detect the backward waves provided from all the radiation units.

Furthermore, while the reflected waves and the through waves are detected in the respective backward wave demodulation units of the plurality of radio-frequency wave generation devices in the present embodiment, the configuration may be such that the reflected waves and the through waves are detected in at least one of the respective backward wave demodulation units of the plurality of radio-frequency wave generation devices.

Furthermore, while the frequencies of the respective radio-frequency wave generation units of the plurality of radio-frequency wave generation devices are changed based on the reflected waves and the through waves in the present embodiment, the configuration may be such that the frequency of at least one of the respective radio-frequency wave generation units of the plurality of radio-frequency wave generation devices is changed.

Furthermore, while the amplification gains of the respective amplifiers of the plurality of radio-frequency wave generation devices are determined based on the reflected waves and the through waves in the present embodiment, the configuration may be such that the amplification gain of at least one of the respective amplifiers of the plurality of radio-frequency wave generation devices is determined.

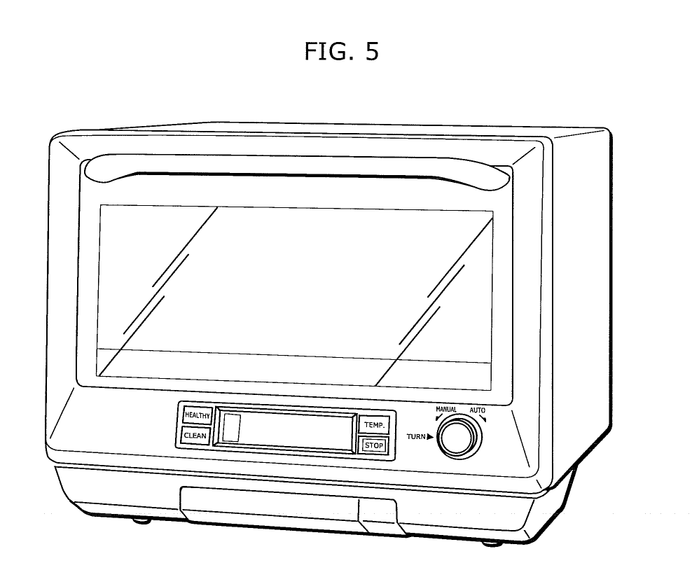

The radio-frequency heating apparatus according to an implementation of the present invention is applicable, for example, as a microwave wave shown in FIG. 5, and the present invention allows determining the optimum heating condition in a short time to heat an object.

The scope of the present invention includes other embodiments that are obtained by making various modifications that those skilled in the art could think of, to these embodiments, or by combining components in different embodiments.

### INDUSTRIAL APPLICABILITY

The present invention is capable of determining the optimum heating condition efficiently in a radio-frequency heating apparatus which includes a plurality of radio-frequency wave generation devices, and therefore useful as a microwave oven and the like.

### REFERENCE SIGNS LIST

100 Radio-frequency heating apparatus

101a First radio-frequency wave generation device

101b Second radio-frequency wave generation device

102 Control unit

103a, 103b Radio-frequency wave generation unit

104a, 104b Signal wave generation unit

105a, 105b Modulator

106a, 106b, 111a Divider

107a, 107b Amplifier

108a, 108b Radiation unit

109a, 109b Backward wave demodulation unit

110a Directional coupling unit

112a First demodulator

113a Second demodulator

120 Heating chamber

1. A radio-frequency heating apparatus comprising:
a heating chamber in which an object to be heated is placed;
a plurality of radio-frequency wave generation devices from which radio-frequency waves are radiated into said heating chamber; and
a control unit configured to control said radio-frequency wave generation devices,
wherein each of said radio-frequency wave generation devices includes:
a radio-frequency wave generation unit configured to generate the radio-frequency waves; a signal wave generation unit configured to generate signal waves for modulating the radio-frequency waves generated by said radio-frequency wave generation unit; a radiation unit configured to radiate modulated waves into said heating chamber, the modulated waves being obtained by modulating, using the signal waves, the radio-frequency waves generated by said radio-frequency wave generation unit; and a backward wave demodulation unit configured to detect backward waves which are part of the modulated waves and enter said radiation unit from said heating chamber,
said backward wave demodulation unit is configured to demodulate the backward waves based on the modulated waves to detect reflected backward waves and pass-through backward waves, the reflected backward waves (i) being part of the radio-frequency waves radiated from said radiation unit of one of said radio-frequency wave generation devices and (ii) being reflected back into said radiation unit of the one of said radio-frequency wave generation devices, and the pass-through backward waves (i) being part of the radio-frequency waves radiated from said radiation unit of another one of said radio-frequency wave generation devices and (ii) entering said radiation unit of the one of said radio-frequency wave generation devices, and
said control unit is configured to control at least one of said radio-frequency wave generation devices based on signals of the reflected backward waves detected by said backward wave demodulation unit and signals of the pass-through backward waves detected by said backward wave demodulation unit.

2. The radio-frequency heating apparatus according to claim 1,
wherein said control unit is configured to determine a frequency of the radio-frequency waves which are to be generated by said radio-frequency wave generation unit, based on the signals of the reflected backward waves detected by said backward wave demodulation unit and the signals of the pass-through backward waves detected by said backward wave demodulation unit.

3. The radio-frequency heating apparatus according to claim 2,
wherein said control unit is configured
(i) to determine one of said radio-frequency wave generation devices in which the frequency of said radio-frequency wave generation unit is to be changed, based on the signals of the reflected backward waves detected by said backward wave demodulation units and the signals of the pass-through backward waves detected by said backward wave demodulation units, and
(ii) to determine the frequency of the radio-frequency waves which are to be generated by said radio-frequency wave generation unit, based on the signals of the reflected backward waves and the signals of the pass-through backward waves obtained when the frequency of said radio-frequency wave generation unit in the determined one of said radio-frequency wave generation devices is changed.

4. The radio-frequency heating apparatus according to claim 1,
wherein said control unit is configured to determine an amplification gain of an amplifier, based on the signals of the reflected backward waves detected by said backward wave demodulation unit and the signals of the pass-through backward waves detected by said backward wave demodulation unit.

5. The radio-frequency heating apparatus according to claim 4,
wherein said control unit is configured
(i) to determine one of said radio-frequency wave generation devices in which the amplification gain of said amplifier is to be changed, based on the signals of the reflected backward waves detected by said backward wave demodulation units and the signals of the pass-through backward waves detected by said backward wave demodulation units, and
(ii) to determine the amplification gain of said amplifier, based on the signals of the reflected backward waves and the signals of the pass-through backward waves obtained when the amplification gain of said amplifier in the determined one of said radio-frequency wave generation devices is changed.

6. The radio-frequency heating apparatus according to claim 1,
wherein said backward wave demodulation unit includes a first demodulator and a second demodulator,
said first demodulator demodulates, using signals of the modulated waves received from the one of said radio-frequency wave generation devices, signals of the backward waves received from said radiation unit,
said second demodulator demodulates, using signals of the modulated waves received from the other one of said radio-frequency wave generation devices, the signals of the backward waves received from said radiation unit, and
the signals of the backward waves demodulated by said first demodulator and said second demodulator are provided to said control unit.
